(19) United States
(12) Patent Application Publication
(10) Pub. No.: US 2007/0192465 A1
(43) Pub. Date: Aug. 16, 2007

(54) Methods, systems, and products for accessing common functions for multiple applications

(76) Inventor: Abdi R. Modarressi, Lawrenceville, GA (US)

Correspondence Address: SCOTT P. ZIMMERMAN, PLLC, PO BOX 3822, CARY, NC, 27519, US

(21) Appl. No.: 11/649,175

(22) Filed: Jan. 3, 2007

Related U.S. Application Data
(60) Provisional application No. 60/772,246, filed on Feb. 10, 2006.

(51) Int. Cl. G06F 15/173

(52) U.S. Cl. 709/223

(57) ABSTRACT

Methods, systems, and products are disclosed for accessing common functions for multiple applications. At least one of a common set of application programming interfaces is received in a request to execute an application. A common set of application service interfaces is accessed that allow access to modular functions that are common amongst the multiple applications. An application service interface is sent in an instruction to execute a modular function, and a result of that modular function is received. The application is then executed.

### CROSS-REFERENCE TO RELATED APPLICATIONS

This application claims the benefit of U.S. Provisional Application No. 60/772,246, filed Feb. 10, 2006, and incorporated herein by reference in its entirety.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND

The exemplary embodiments generally relate to computers and to communications and, more particularly, to interfaces or calls to common functions.

Next-generation networks are converging. As next-generation networks evolve, a common consensus is developing. Some in the communications industry used to believe that separate transport networks were desirable for some service applications. Now, however, the communications industry is changing and converging toward one connectivity network (e.g., I.P.—based networks). The next-generation networks will be one interconnected, logical network, regardless of who owns portions of its physical infrastructure.

Because next-generation networks are converging, application services should also change. The conventional paradigm is that each application would use its own transport network to provide a service. Voice telephony applications, for example, conventionally utilize wired and wireless circuit-switched networks, whereas video applications utilize DBS and HFC infrastructures, email/IM and information services utilize the Internet, and signaling and control utilizes an SS7 network infrastructure. FIG. 1 illustrates this prior art architecture, in which an application layer 20 is shown as a collection of more or less independent application stacks 22. Each conventional application stack 20 includes one or more supporting functions 24. These supporting functions 24, for example, may include billing functions 26, location-based functions 28, messaging functions 30, quality of service functions (“QoS”) 32, and others. As FIG. 1 illustrates, each conventional application stack 22 is individually designed to include the supporting functions 24. These conventional application stacks 20 may then communicate with end devices 34 via a communications network 36.

Functional commonality, then, is desirable. When next-generation applications are developed, application service providers should be able to have common functions across applications. Regardless of whether these applications are VoIP, IPTV, wireless/wireline, gaming, or unified messaging, these applications should exhibit some level of commonality, due to the industry convergence toward one interconnected, logical network. That is, while all these next-generation applications may have differences in their programming logic, many of these next-generation applications could have common functions or components. So, there is no need to redevelop these common functions or components for each application. These common functions or components could be developed once and then called or reused whenever an application desires. What is needed, then, are methods, systems, and products for developing a middle-layer infrastructure that relieves individual applications from performing common functions.

### SUMMARY

The exemplary embodiments provide methods, systems, and products for middle-layer technologies. These middle-layer technologies exploit common functions or components across multiple applications. According to exemplary embodiments, application developers need not develop these common functions or components. Developers may simply call or access modular functions when needed. Developers need not develop or include programming logic for these common functions or components. Because developers are not including these modular functions in their applications, developers may bring their applications to market in a shorter length of time and at a lower cost. Exemplary embodiments thus reduce the cost and time of developing applications to support next-generation networks and services.

Exemplary embodiments include a method for accessing common functions for multiple applications. At least one of a common set of application programming interfaces is received in an instruction to execute an application. A common set of application service interfaces is accessed that allow access to modular functions that are common amongst the multiple applications. An application service interface is sent in an instruction to execute a modular function, and a result of that modular function is received. The application is then executed.

More exemplary embodiments include a system for accessing common functions for multiple applications. A processor communicates with memory, and the memory stores instructions for receiving at least one of a common set of application programming interfaces in an instruction to execute an application. A common set of application service interfaces is accessed that allow access to modular functions that are common amongst the multiple applications. An application service interface is sent in an instruction to execute a modular function, and a result of that modular function is received. The application is then executed.

Other exemplary embodiments describe a computer program product for accessing common functions for multiple applications. The computer program product stores instructions for receiving at least one of a common set of application programming interfaces in an instruction to execute an application. A common set of application service interfaces is accessed that allow access to modular functions that are common amongst the multiple applications. An application service interface is sent in an instruction to execute a modular function, and a result of that modular function is received. The application is then executed.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a schematic illustrating prior art;

FIG. 2 is a simplified schematic illustrating common, modular functions, according to exemplary embodiments;

FIGS. 3-6 are schematics illustrating an operating environment in which exemplary embodiments may be implemented;

FIG. 7 is a schematic illustrating a middle layer architecture having SIP-based capabilities and Web Services capabilities, according to more exemplary embodiments;

FIG. 8 is a schematic illustrating an IMS-compliant architecture for the middle layer, according to still more exemplary embodiments;

FIG. 9 is a schematic illustrating a Web Services architecture for the middle layer, according to even more exemplary embodiments;

FIG. 10 is a schematic illustrating another architecture for the middle layer, according to more exemplary embodiments; and

FIG. 11 is a schematic illustrating yet another architecture for the middle layer, according to more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

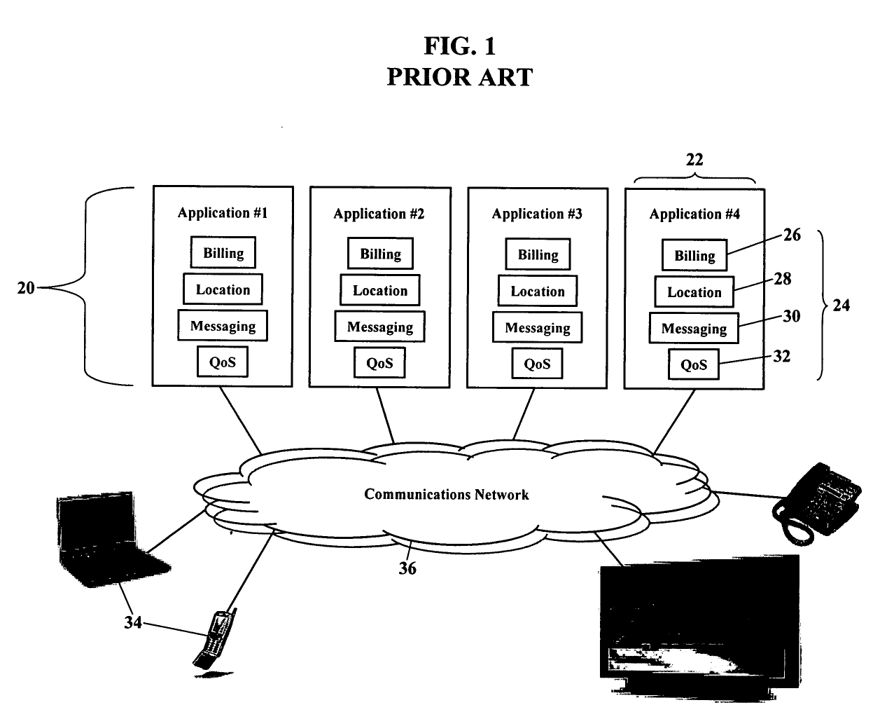

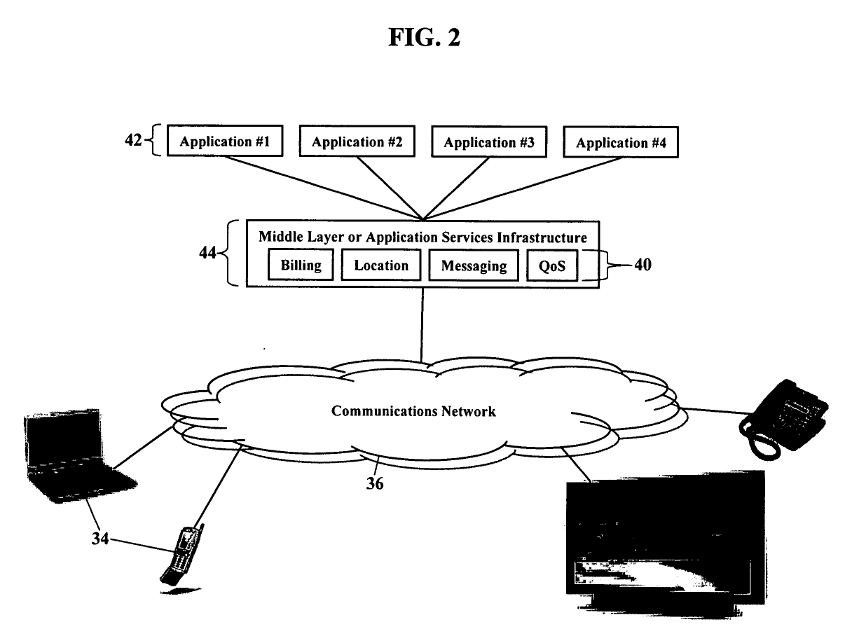

FIG. 2 is a simplified schematic illustrating common, modular functions, according to exemplary embodiments. FIG. 2 illustrates an alternative to the conventional “silo” or “stack” model of application development depicted in FIG. 1. Here, a set 40 of modular functions that are actually or potentially deemed common and needed across multiple applications 42 are removed or “pulled out” of the individual applications. According to exemplary embodiments, the set 40 of modular functions are abstracted and architected in a separate, distinct middle layer 44. This middle layer 44 is herein termed the Application Services Infrastructure (or “ASI”). The multiple, but different, applications 42 invoke the middle layer capabilities on an as-needed basis to provide customers with services. Exemplary embodiments may even permit customers to access any of these middle layer modular functions, independent of a particular application, if desired. Some generic capabilities provided by the Application Services Infrastructure middle layer 44 may include authentication (single sign-on), presence and availability, location, mobility management, user and device profile management, directory services (for both people and services), security management, notification, subscription, session control, service brokering, QoS management, access to PSTN, access to billing, interfaces to OSS and BSS, links into service creation, and any other reusable capabilities. The Application Services Infrastructure or middle layer 44 thus comprises modular functions that actually or potentially are reusable across the multiple applications 42. Each modular function in the set 40 of modular functions may even constitute an autonomous domain which can be analyzed and architected more or less in parallel with other middle layer capabilities. The Application Services Infrastructure middle layer 44 may interface with specific applications through northbound interfaces, with the connectivity network through southbound interfaces (e.g., for managing QoS), with customers through web-based interfaces (over an appropriate access like DSL/WiFi), and with BSS/OSS functions through web-services interfaces within a Service Oriented Architecture (SOA). In addition, middle layer service components can interact with one another in support of an application.

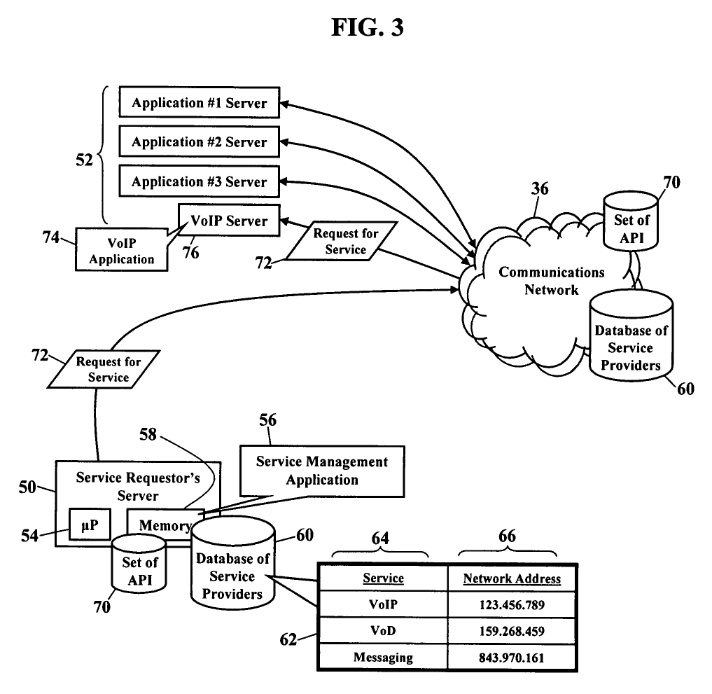

FIGS. 3-6 are schematics illustrating an operating environment in which exemplary embodiments may be implemented. A service requester's server 50 communicates with one or more application service providers' servers 52 via the communications network 36. When a service is needed, the service requester's server 50 calls or invokes the proper service application. The service requester's server 50 has a processor 54 (e.g., “μP”), application specific integrated circuit (ASIC), or other similar device that executes a service management application 56 stored in memory 58. The service management application 56 is a software engine or computer program that calls or invokes service applications to provide the needed service.

The service management application 56 accesses a database 60 of service providers. The database 60 of service providers may be locally stored in the memory 58, or the database 60 of service providers may be remotely accessed via the communications network 36. Regardless, the database 60 of service providers stores a table 62 that maps, relates, or otherwise associates the requested service 64 to a server network address 66. That is, the table 62 identifies which of the application service providers' servers 52 will provide the requested service. The service management application 56 queries the database 60 of service providers for the server address 66 that corresponds to the desired service.

The service management application 56 also accesses a common set 70 of application programming interfaces (“API”). The common set 70 of application programming interfaces may be locally stored in the memory 58 or remotely accessed via the communications network 36. However the common set 70 of application programming interfaces is accessed, the common set 70 of application programming interfaces provides standard software commands or requests that are commonly shared amongst the application service providers' servers 52. Because the service requester may partner with many different application vendors, the service requestor could experience compatibility problems. Each of the application vendors may utilize different hardware and software configurations, thus creating a diverse environment that ordinarily presents compatibility problems. According to exemplary embodiments, the common set 70 of application programming interfaces, however, provides common calls to any of the application service providers' servers 52 and/or to any application operating in the servers 52. The common set 70 of application programming interfaces permits the service management application 56 to make requests or to exchange data with the servers 52, regardless of hardware and software differences. Because application programming interfaces are known, this disclosure will not further discuss the common set 70 of application programming interfaces.

According to exemplary embodiments, the service management application 56 sends a request 72 for service. The request 72 for service may request any feature or capability offered to a customer, and the customer may or may not be billed for the service. The term “customer” includes both end-user customers and other service requestors/providers. Once the network address 66 (that corresponds to the requested service) is known, and once the proper application programming interfaces are known (from the common set 70 of application programming interfaces), the service management application 56 sends the request 72 for service to the network address 66. FIG. 3, for simplicity, illustrates the request 72 for service communicating via the communications network 36 to a VoIP application 74 operating in a VoIP service provider's server 76. The request 72 for service may include any service information that is needed by the VoIP application 74, or by the VoIP service provider's server 76, to perform the service. The request 72 for service instructs the VoIP service provider's server 76 to run, perform, or otherwise execute the VoIP application 72.

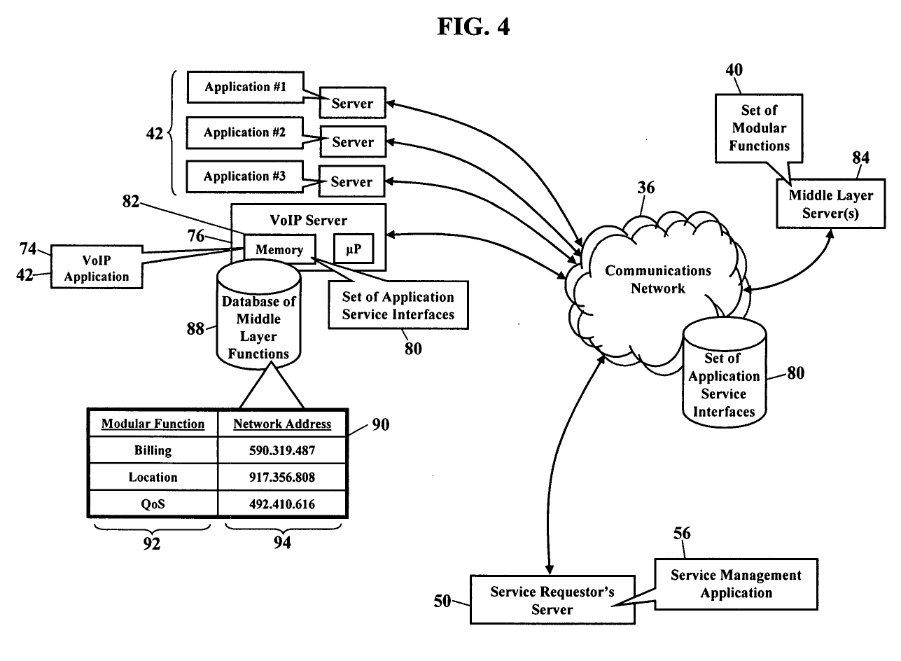

As FIG. 4 illustrates, a common set 80 of application service interfaces is accessed. The common set 80 of application service interfaces provides standard software commands or requests that are commonly shared amongst the multiple applications operating in the application service providers' servers 52. The common set 80 of application service interfaces, for example, is illustrated as being locally stored in the memory 82 of the VoIP service provider's server 76, yet the common set 80 of application service interfaces may be remotely accessible via the communications network 36. The common set 80 of application service interfaces allows access to the set 40 of modular functions. The set 40 of modular functions are common amongst the multiple applications 42. As the above paragraphs previously explained, the set 40 of modular functions includes any features, functions, or capabilities that are actually or potentially deemed common across the multiple service applications 42. The common set 40 of modular functions are removed or “pulled out” of the individual applications 42 and, instead, provided by middle layer servers 84 (e.g., the Application Services Infrastructure). The multiple applications 42 invoke the middle layer capabilities on an as-needed basis to provide the requested service. The VoIP application 74, for example, invokes the common set 80 of application service interfaces when a call for a common, modular function is needed.

The service application 42 may also access a database 88 of middle layer functions. The database 88 of middle layer functions may be locally stored in the memory 82 (or remotely accessed via the communications network 36). Regardless, the database 88 of middle layer functions stores a table 90 that maps, relates, or otherwise associates modular functions 92 to a middle layer server's network address 94. That is, the table 90 identifies which of the middle layer servers 84 (in the middle layer 44 shown in FIG. 2) will provide the desired modular function. The VoIP application 74, for example, queries the database 88 of middle layer functions for the server address 94 that corresponds to the desired modular function.

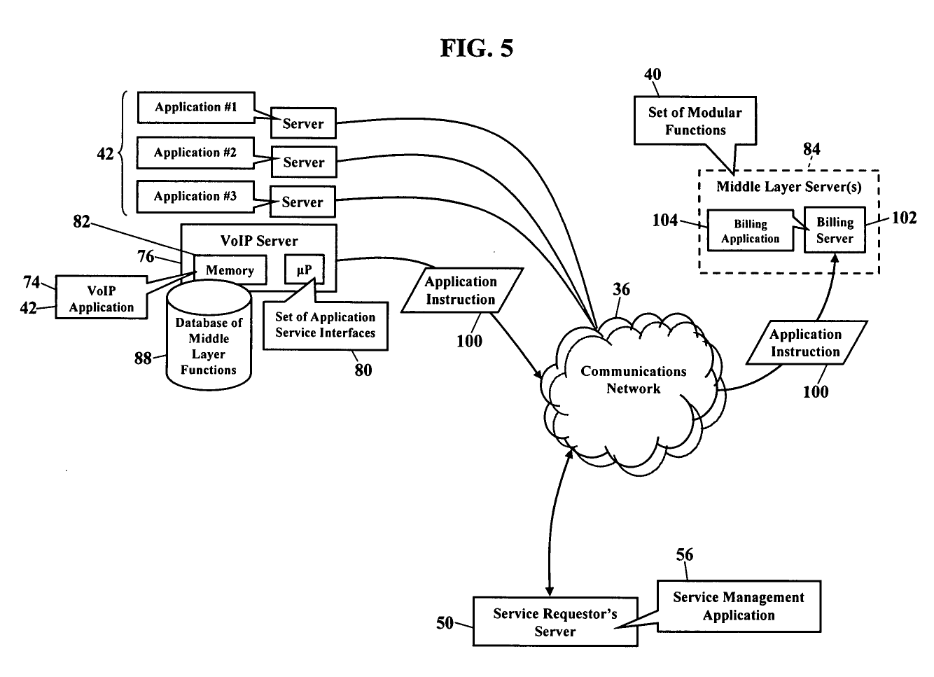

As FIG. 5 illustrates, an application instruction 100 is sent. When any of the multiple service applications 42 requires one or more of the common, modular functional capabilities available from the middle layer server(s) 84, the service application 42 obtains the appropriate command(s) or request(s) from the common set 80 of application service interfaces. The service application 42 then sends the application instruction 100 to the appropriate middle layer server's network address (available from the database 88 of middle layer functions) that provides the modular function. The application instruction 100 may include or describe one or more of the common set 80 of application service interfaces. The application instruction 100 may also include any information that is needed to perform the modular function. The application instruction 100 instructs the identified middle layer server 84 to run, perform, or otherwise execute the modular function. FIG. 5, for example, illustrates the VoIP application 74 sending the application instruction 100 to a billing server 102 that executes a billing application 104. The billing server 102 thus provides a modular billing function to the VoIP application 74.

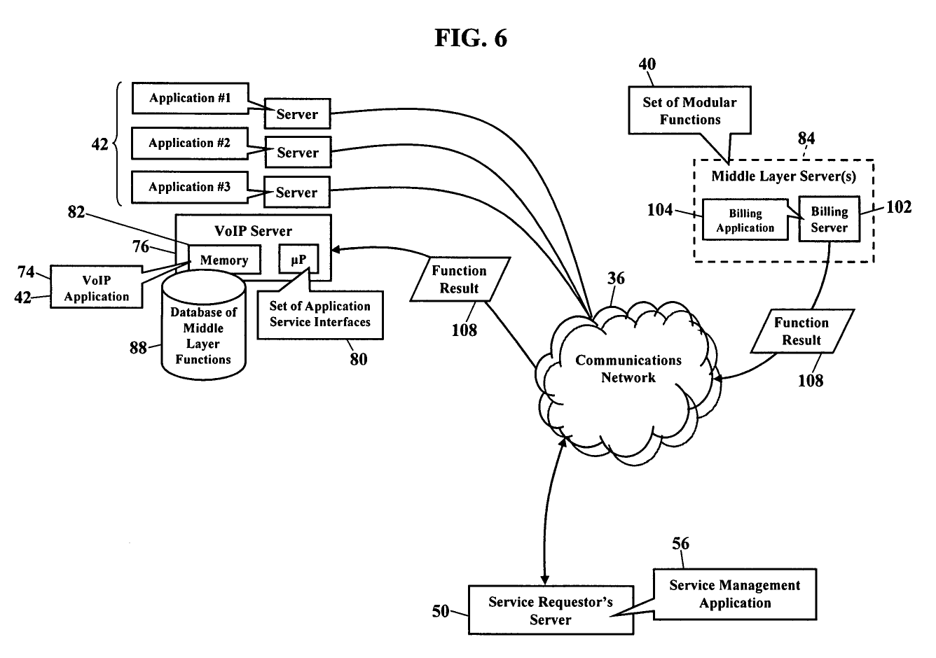

FIG. 6 illustrates a function result message 108. When the middle layer server(s) 84 executes the modular function, the middle layer server 84 then sends the function result message 108. FIG. 6, for example, illustrates the middle layer billing server 102 sending the function result 108 to the VoIP service provider's server 76 via the communications network 36. The function result 108 comprises information that describes a result of the modular billing function provided by the billing application 104. When the VoIP service provider's server 76 receives the function result 108, the VoIP application 74 may then continue executing its logical code (such as continuing to execute the VoIP service).

Exemplary embodiments provide functional modules for next-generation services. The term “next generation network” (or “NGN”) means a converged network that delivers advanced services of all varieties using any available device and/or media (e.g. voice, video, data, gaming, signaling and/or control, management, and connectivity). At the connectivity level, NGN will resemble the Internet with one crucial difference. It will be like the Internet in its ubiquity, in the use of different evolving access and backbone technologies, and most importantly in its universal use of any packetizing protocol (such as the Internet Protocol). NGN connectivity, however, may be quality-of-service (QoS) enabled, and it may ultimately support QoS on demand. The term “Quality of Service” is used in its broadest sense to include bandwidth, delay, delay variation (e.g., jitter) and other relevant metrics.

Exemplary embodiments are applicable to any service application 42. As those of ordinary skill in the art recognize, the services that are currently offered are too numerous to individually describe. Moreover, it is challenging to predict those services that may flourish in next generation networks. Nonetheless, from a customer's viewpoint, the majority of next generation application services may be broadly categorized as:
Communication/Collaboration Services: These services can be viewed as evolution of today's wired or wireless voice telephony on the real-time side, and voicemail/email on the non-real-time side. As voice increasingly becomes another data application with VoIP, it is easy to see from existing trends that it will be enhanced initially with useful data features, and eventually with capabilities that will transform it into full-fledged voice-data-video communication. Similarly, voicemail, email and IM will become more unified and assume a multimedia character. Seamless mobility will be interwoven into communication services ubiquitously.
Entertainment/Education Services: This set of application services deals with delivering rich-media content to the customer. IP-TV, Video-on-demand, music-on-demand, multi-player gaming and similar services are all examples in this category, which can be offered either on-demand as streaming applications with advanced end-user control or, alternatively, in conjunction with a network PVR capability on a time-shifted basis.
Data/Information Services: This category may represent a “catch all” class and will encompass evolution of today's Internet applications. At the minimum, application services that fall into this category will include enhanced browsing, searching, information retrieval, software distribution, productivity applications, e-commerce, location, push services, as well as future developments.
Middle Layer Services: This class of services supports other application services. A large number of next generation customer facing applications are not simply viable without authentication, billing, security, screening, profile, presence, notification, directory, QoS management, session control, performance monitoring or similar support capabilities that will also make them easy and convenient to use. These capabilities can potentially become part of the reusable middle-layer that supports customer facing applications and provides great opportunities for competitive differentiation.

Unlike legacy networks, NGN will have to support multi-modal capabilities in delivering services to its users. Each mode or medium may have its own unique connectivity/QoS needs. Furthermore, multi-party capabilities on-demand, where a participating entity in a service can be a human or a machine, will need to be supported for an increasing number of next generation applications (conferencing, gaming, collaboration). The on-demand multi-media, multi-party nature of next generation applications may require session control and management in NGN (contrasted with call control and management in the conventional PSTN).

Mobility will be woven into many next generation applications. Whereas mobility is currently confined to circuit-switched cellular service, it is indisputable that user, terminal, and session/application mobility will become indispensable attributes of most next generation services. This will result in full wireless-wireline convergence, a convergence that will ultimately be made complete by the ubiquitous use of packet switching in all wireless and wireline networks.

Exemplary embodiments are also applicable to any third party service provider. NGN applications may be developed by third-party application service providers (ASPs), a natural consequence of the separation of connectivity from applications. NGN providers may support, and even mediate, the flow of third party applications to customers.

The Application Services Infrastructure (e.g., the middle layer 44 shown in FIG. 2) is an improvement. From an end user's vantage point, for example, the middle-layer capabilities provide several important advantages. First, users may access middle-layer services in a way that is independent of any particular application 42. For example, if the middle layer includes a directory server, the user may access that server via a web interface to browse and locate people as well as applications and their descriptions. Any user or customer may access a profile server in the middle layer to create and edit his/her profile and preferences. Users may also access a presence/availability server in the middle layer to check on a party's presence or availability. The middle layer may include a subscription server to subscribe to a service application and/or to establish a billing profile. Second, specific functions within the middle layer allow users to mix, match, and/or compose various application services to create a richer more sophisticated experience. A session control function in the middle layer, for example, allows a user to launch a multimedia communication session with another user and, without a prior bandwidth reservation, add other parties or even other devices/applications (e.g., a video server, a web server, or a gaming server) to the session. Feature interaction within such composite services would be taken care of by the service broker in the middle layer resulting in useful enhancements to user's experience and productivity. Third, users benefit from the underlying sharing of customer-specific data such as authentication, preferences, service data, and subscription/billing information across all relevant applications, and the presentation of a unified interface for managing such data. Finally, the existence of the unified middle layer enables users to invoke a large number of third party applications in a uniform way with the common set 80 of application service interfaces.

The Application Services Infrastructure (e.g., the middle layer 44 shown in FIG. 2) also provides benefits to service providers and to developers. As the above paragraphs earlier mentioned, the reuse of the set 40 of modular functions minimizes duplicate efforts. The set 40 of modular functions also provides cost savings and a reduction in time to market of application services. In addition, the middle layer provides a powerful means of application differentiation in a very competitive environment. Such differentiation can occur at different levels. For example, at the user interface level, the middle layer enables a rich unified and consistent experience for access to all services, with as much a common look-and-feel as it makes sense across multiple devices. The middle layer enables a high degree of customer control and customization. The middle layer also hides the complexities and inconsistencies the customers would otherwise experience in dealing with third party ASPs by providing consistent common capabilities. Finally, the middle layer allows the service provider to experiment with different business models in providing application services; for example, by positioning itself as the trusted “primary” or “continuous” service provider or intermediary (depending on the application) that satisfies all communication, entertainment, information, and data needs of its customers.

The Application Services Infrastructure (e.g., the middle layer 44 shown in FIG. 2) also provides benefits to third-party service providers. The middle layer allows partner ASPs to focus on developing their specific application logic (e.g., their core competency) without being encumbered with development of ancillary and support capabilities for their applications. The middle layer provides any of the generic application support components. Because the set 40 of modular functions provides cost savings and a reduction in time to market of application services, their party service providers respond more quickly to market needs and customer demands.

The service requester's server 50, and the application service providers' servers 52, are only simply illustrated. Because their architecture and operating principles are well known, their hardware and software components are not further shown and described. If the reader desires more details, the reader is invited to consult the following sources, all incorporated herein by reference in their entirety: ANDREW TANENBAUM, COMPUTER NETWORKS (4^{th} edition 2003); WILLIAM STALLINGS, COMPUTER ORGANIZATION AND ARCHITECTURE: DESIGNING FOR PERFORMANCE (7^{th} Ed., 2005); and DAVID A. PATTERSON & JOHN L. HENNESSY, COMPUTER ORGANIZATION AND DESIGN: THE HARDWARE/SOFTWARE INTERFACE (3^{rd}. Edition 2004).

Exemplary embodiments may be applied regardless of networking environment. The communications network 36 may be a cable network operating in the radio-frequency domain and/or the Internet Protocol (IP) domain. The communications network 36, however, may also include a distributed computing network, such as the Internet (sometimes alternatively known as the “World Wide Web”), an intranet, a local-area network (LAN), and/or a wide-area network (WAN). The communications network 36 may include coaxial cables, copper wires, fiber optic lines, and/or hybrid-coaxial lines. The communications network 36 may even include wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

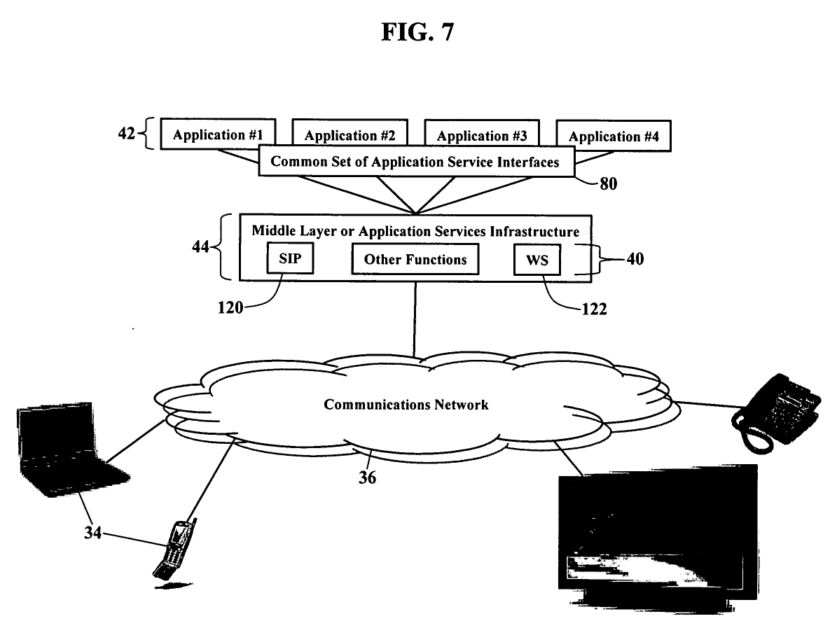

FIG. 7 is a schematic illustrating the middle layer 44 having SIP-based capabilities and Web Services capabilities, according to more exemplary embodiments. Here the common set 80 of application service interfaces supports calls, commands, and/or requests for common Session Initiation Protocol (“SIP”) applications 120 and for web-based services (“WS”) applications 122. The common set 80 of application service interfaces allows access to real time, interactive application services that need to be set up, delivered, and controlled with very low latency and very high reliability. Voice telephony, and its evolution into multi-media multi-party communication, is an example of these types of applications. The common set 80 of application service interfaces also allows access to application services whose delivery and control are more tolerant to latency. Data-oriented applications, as well as non-interactive content delivery services such as IP-TV, are examples of these types of applications. The common set 80 of application service interfaces thus supports the Session Initiation Protocol (SIP) and its associated technologies and Web Services (within the broad context of Service Oriented Architectures) and its associated technologies (XML, WSDL, SOAP). As next generation application services lose their “stovepipe” nature and become increasingly more intertwined and composite, elements of both universes will need to be present and supported in the repertoire of converged next generation services. For example, next generation networks should enable one to launch feature-rich multi-modal communication capabilities (SIP-based) with information sharing (web-based), multimedia conferencing (SIP-based) with advanced collaboration (web-based), multi-player gaming (web-based) with real-time interactive communication (SIP-based), video-on-demand with both web-oriented and communication-oriented interactions, intelligent routing of calls based on presence and profile, e-commerce enhanced with information and communication features that relate to product marketing and support, and education and training services that will virtually erase the distance barrier by providing near-presence experience in delivery and control. FIG. 7, then, illustrates the middle layer 44 encompassing technologies from the network universe using SIP and the IT universe using Web Services. Because the middle layer 44 provides reusable capabilities to converged and bundled services, here the unified middle layer 44 includes both SIP and IT capabilities.

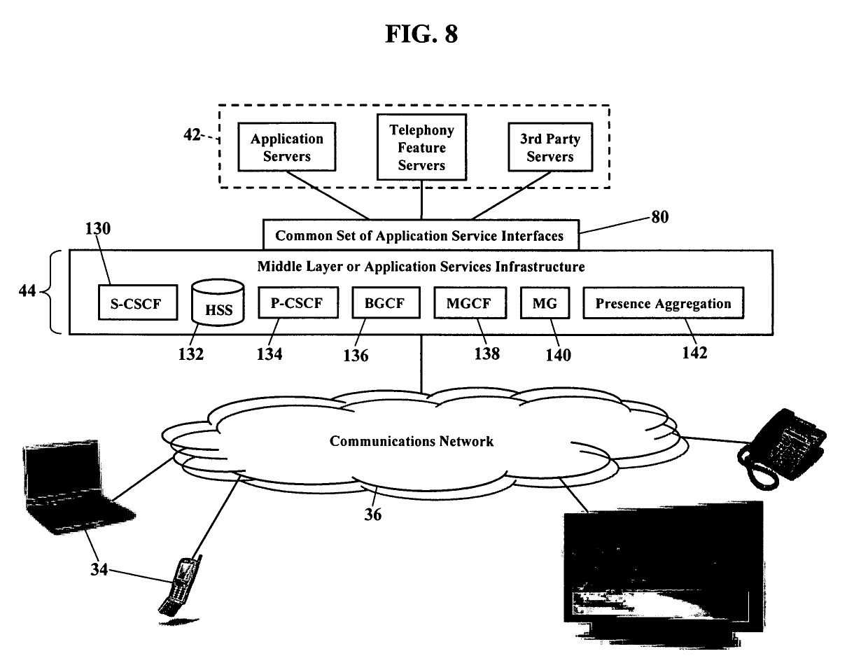

FIG. 8 is a schematic illustrating an IMS-compliant architecture for the middle layer 44, according to still more exemplary embodiments. Here an IP Multimedia Subsystem (or “IMS”) supports a network-side of the middle layer 44. The IMS architecture may involve the concept of a “session” as the generalization of a “call” in PSTN. A session defines a context (or container) into which different applications and users, each with their own QoS needs and billing/charging requirements, may be brought together and managed. The common set 80 of application service interfaces allows access to a Serving Call Session Control Function (“S-CSCF”) 130 that performs the session management function. The common set 80 of application service interfaces also allows access to a Home Subscriber Service (“HSS”) master database 132. The Home Subscriber Service master database 132 is a centralized repository that stores customer subscription and service data for the multiple applications 42. This logical centralization acts as an enabler for the middle layer 44 to implement other capabilities such as authentication, subscription, profile, presence, and billing and turn them into reusable components across the multiple applications 42.

The common set 80 of application service interfaces also permits access to other functions. As applications evolve from being voice-centric in PSTN to multi-media services in NGN, careful management of resources and QoS, including admission control, through appropriate crafting and enforcement of policies at different levels is desired for the successful rollout of new services in a reliable and consistent manner. IMS enables such mechanisms by defining a Policy Decision Function (in conjunction with a Proxy Call Session Control Function or “P-CSCF” 134) that can be architected to act as admission control and QoS policing entity interfacing with the resources of the underlying connectivity network. The common set 80 of application service interfaces thus includes common calls, commands, and/or requests to the Proxy Call Session Control Function 134. Moreover, the need to interact with legacy services in PSTN during the transition period has led to definition and adoption in IMS of special reusable capabilities including a Border Gateway Control Function (“BGCF”) 136, a Media Gateway Control Function (“MGCF”) 138, and a Media Gateway (“MG”) 140 to allow converged services to encompass SIP packet components as well as PSTN/GSM circuit components. The common set 80 of application service interfaces also includes common calls, commands, and/or requests to these legacy capabilities.

The common set 80 of application service interfaces also permits access to presence functions. As FIG. 8 illustrates, the common set 80 of application service interfaces allows access to a modular presence aggregation function 142. The presence aggregation function 142 is a reusable function that may be reused by any of the multiple applications 42 when network presence is needed.

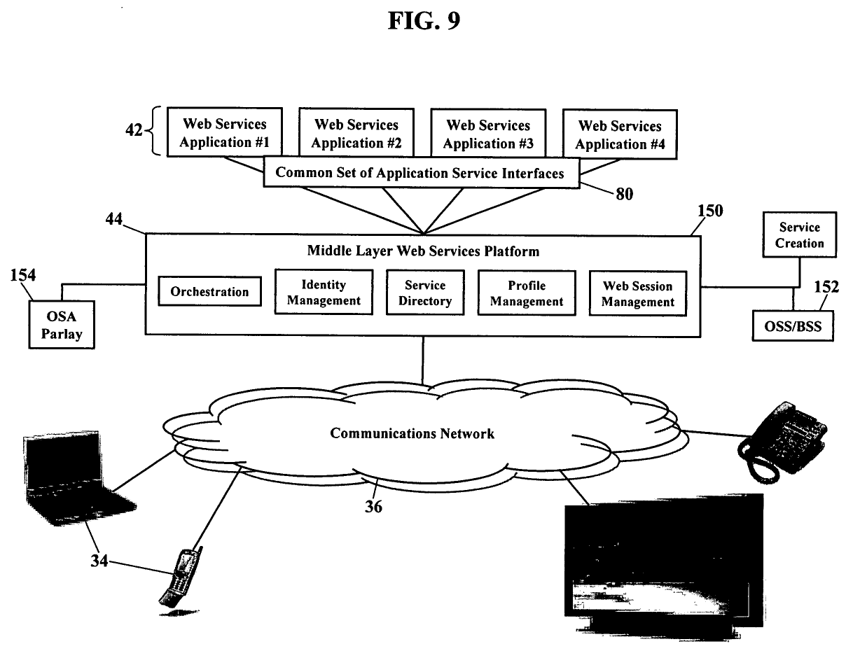

FIG. 9 is a schematic illustrating a Web Services architecture for the middle layer 44, according to even more exemplary embodiments. Here the common set 80 of application service interfaces includes any reusable functions that support web-oriented services. The web-oriented portion of the middle layer 44 is herein termed a “Web Services Platform” (or “WSP”) 150. The common set 80 of application service interfaces provides access to WSP-provided capabilities, which can be invoked by a variety of near-real-time web applications. These capabilities include service orchestration, web session management, single sign-on and identity management, service directory, user profile management, notification, etc. The common set 80 of application service interfaces supports a common interface to Operation Support Systems (“OSS”) and/or Business Support Systems (“BSS”) 152 (both next-generation and legacy systems). OSS interfaces facilitate fault, configuration, and performance management while BSS interfaces facilitate use of billing and business process capabilities. The common set 80 of application service interfaces also provides an interface to IMS through an OSA/Parlay 154 gateway to consume network capabilities, such as third party call control. The common set 80 of application service interfaces also supports a unified service creation environment. In short, the Web Services Platform 150 provides middle layer, web-side capabilities (similar to the middle layer capabilities that IMS provides on the network side). These middle layer services are then invoked on a need basis by the different web centric applications 42 through a user interface. The common set 80 of application service interfaces may also provides access to the communications network 36 that provides the transport infrastructure on which WSP and its supported applications ride.

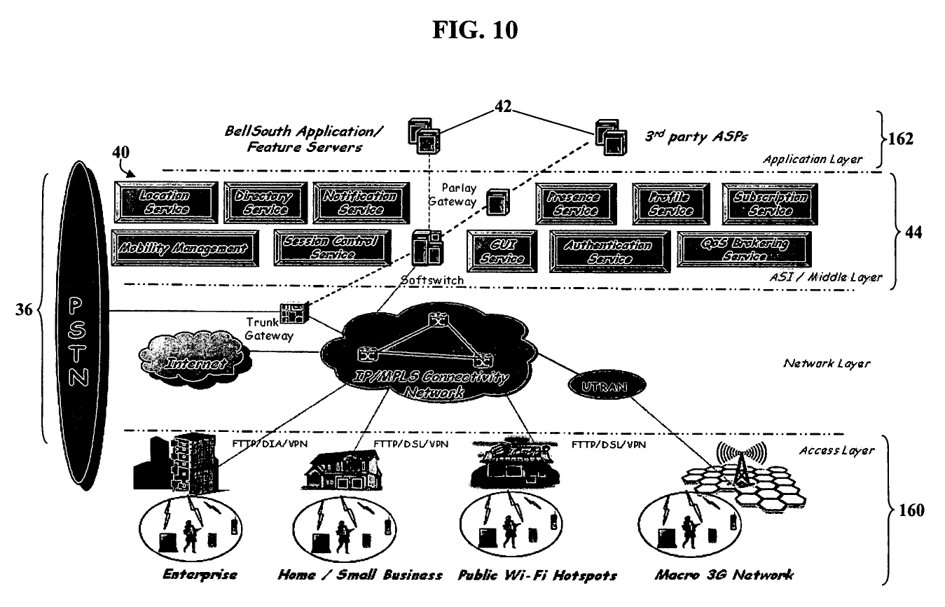

FIG. 10 is a schematic illustrating another architecture for the middle layer 44, according to more exemplary embodiments. Here the middle layer 44 supports all varieties of converged and blended services in next generation networks using an IMS+WSP architecture. The middle layer 44 provides reusable capabilities that applications can invoke to provide their full functionality to users. End users 160 access services through any communications devices, such as wired or wireless phones, PDAs, PCs, and TVs. The end users are divided into four market segments (enterprise, residential/SOHO, public venues, and macro cellular). The communications network layer 36, in conjunction with a variety of access infrastructures (e.g., DSL, WiFi, and/or Cable), is used to provide end-to-end IP connectivity with appropriate QoS from access through backbone and egress. An application layer 162 illustrates the multiple customer facing applications 42 that may be provided by a next-gen service provider or by third parties that would use the service provider's infrastructure to offer the service. The common set 80 of application service interfaces provides common calls, commands, and/or requests to the set 40 of modular functions represented in the middle layer 44 (or the Application Services Infrastructure).

FIG. 10 illustrates only some of the modular functions. The set 40 of modular functions illustrated in the middle layer 44 may include any functional capability that has, or may in the future have, reusable value across the multiple applications 42. Each modular function may be an autonomous domain that can be analyzed and architected independent of other domains. The set 40 of modular functions may include session control, mobility management, real-time service brokering, and QoS brokering. Other modules in the middle layer 44, such as a subscription service, notification service, and profile management service, may equally support real-time and near-real-time applications. As a first approximation, then, IMS can be considered to provide the portion of the middle layer capabilities that are needed by real-time applications. Similarly, the WSP (shown as reference numeral 150 in FIG. 9) may be considered as constituting some of the reusable capabilities needed by near-real-time applications. In other words, the IMS may constitute the network (i.e. real-time) side of the middle layer 44, and the WSP as the web (i.e. near-real-time) side of the middle layer (initially with OSA/Parlay as the gateway connecting them). Exemplary embodiments thus provide a capability to “mix” or blend applications from both sides to create more useful converged services to fit a blended lifestyle.

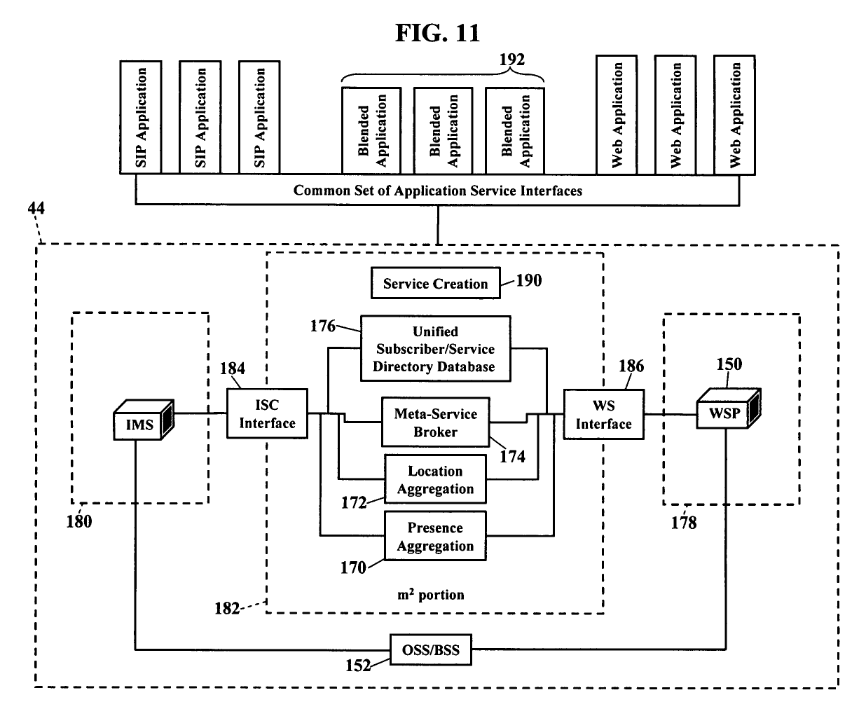

FIG. 11 is a schematic illustrating yet another architecture for the middle layer 44, according to more exemplary embodiments. FIG. 11 illustrates an architectural configuration in which the set 40 of modular functions straddles the worlds of SIP/IMS and that of WSP/web services. The set 40 of modular functions may again be used by the multiple applications 42 and may be stored, linked, and accessed as autonomous website domains. For convenience and ease of reference, these functional modules may be termed “middle of the middle” or simply “m²” capabilities. The set 40 of modular functions may include a presence aggregation module 170, a location aggregation module 172, a metaservice broker 174, and a unified subscriber/service directory database 176. The set 40 of modular functions may also include policy servers, notification servers, and any other reusable programming modules stored in servers.

FIG. 11 also illustrates dual interfaces. Any middle-layer functions that are primarily needed by applications serving the Web Services Platform 150 are provided within a WSP portion 178 of the middle layer 44. Any middle layer functions that are primarily needed by applications providing SIP capabilities are provided within an IMS portion 180 of the middle layer 44. The “middle of the middle” functions are illustrated as an “m²” portion 182 of the middle layer 44. These m² functions may be needed by both real time (SIP/IMS) and near-real-time (WS) applications and have dual interfaces: an ISC interface 184 to the IMS portion 180 of the middle layer 44, and a web services interface 186 to the WSP portion 178 of the middle layer 44. The presence aggregation module 170 and the location aggregation module 172 may operate in servers that receive multiple feeds from various sources of presence and location. The unified subscriber/service directory database 176 is also likely to be needed by applications on both sides.

The metaservice broker 174 may also have dual interfaces. The metaservice broker 174 provides service brokering and mediation capability that allows service providers to offer truly converged services with applications and features drawn from both the IMS portion 180 and the WSP portion 178. One of the great values of IMS is its promise of blended applications. Full blending of applications implies provision of capabilities that ensure the correct and smooth invocation of different applications and management of potential interactions between their features. IMS core functionality takes the initial steps in blending applications by providing a “sequencing” capability for application invocation in the form of “filter criteria” stored in the unified subscriber/service directory database 176 under subscriber's profile (and used by the S-CSCF 130 shown in FIG. 8). Realizing the need for more sophisticated brokering capability, 3GPP has defined a “place holder” (e.g., a Service Capability Interaction Manager or “SCIM”) at the IMS application layer to manage more complex brokering and feature interaction among multiple SIP/IMS applications. While the SCIM capabilities are still being defined, many SCIM-like capabilities may be left to vendors and service providers as a vehicle for differentiation and innovation. The WSP portion 178 may also provide capabilities for brokering and mediating web sessions and may be captured in web session management and orchestration modules.

The metaservice broker 174, then, may also have dual interfaces. Because service brokering and mediation capability is needed to offer truly converged services, the metaservice broker 174 also has the ISC interface 184 and the web services interface 186. According to exemplary embodiments, the metaservice broker 174 not only allows service blending and packaging (to facilitate accounting, for example), but the metaservice broker 174 will also let features of one application enhance the capabilities of another application to provide more useful end user services.

FIG. 11 illustrates still more interfaces. A set of interfaces to the Business Support Systems (BSS) and to the Operation Support Systems (OSS) 152 may be desired to both the IMS portion 180 and the WSP portion 178. These BSS/OSS interfaces help ensure reliable, full-cycle management of application services from ordering to provisioning and from activation to trouble management and billing. These interfaces may be SOA based and may be on either the IMS portion 180 and the WSP portion 178. A service creation module 190 may interface with not only the IMS portion 180 and the WSP portion 178, but the service creation module 190 may also interface with the OSS/BSS 152 for provisioning and activation and, most importantly, with the metaservice broker 174 for creation of blended services.

Some examples help explain exemplary embodiments. These examples of converged and blended services may have functional parts derived from both the IMS side and the web side of FIG. 11. An interactive network gaming application, for example, may be architected on the web services side that provides a capability for garners to talk with each other, thus invoking a VoIP application on the IMS side and blending it with gaming. Furthermore, an m² capability to ascertain the presence and availability of potential participants before inviting them into the game could potentially be a useful feature.

Another example blends web services with telephony. Assume that an IPTV application and a Video-on-Demand application are architected on the WSP side. The user's communications device receives a stream of data (such as video-on-demand content). When a network device detects an incoming call to the user's communications device, a message may be inserted into the streaming video data. The message may cause a “pop-up” notification to appear on a display device that informs the user of the identity of the calling party. The user may have the option of sending/forwarding the call to a busy or customized announcement, redirecting the call to another number or voicemail, or answering the call. If the user decides to answer the call, the streaming video-on-demand data may be stopped and buffered (locally or in a network device). Here, again, a web services application is blended with telephony on the IMS side. Additionally, IPTV viewers could access and blend their SIP-based unified messaging service with their video delivery service.

Another example allows users to blend sessions with web services. Suppose an IMS or video session is established between one or multiple users. One of those users may wish to invoke a portal service application that allows the users to collaborate, thus sharing content and/or calendaring entries. All the parties to the session may thus jointly view and interact with the shared content. Here the users start with an IMS service and invoke some web services in conjunction with an already established IMS session.

Another example describes a blended, intelligent routing service. There are many types of an intelligent routing (e.g., find-me or follow-me) services that may be described as a blended service. Suppose, for example, that an incoming call on the IMS side triggers look up queries to the presence aggregation module 170 and/or to the location aggregation module 172 (e.g., the “middle of the middle” functions illustrated as the “m²” portion 182 of the middle layer 44 in FIG. 11). These queries check the called party's availability and preference before routing the incoming call. Furthermore, the calling party's number or other communications address may trigger an application within the WSP portion 178 of the middle layer 44. This web-services application may fetch the caller's profile from a BSS platform and send it along with the incoming call to the called party's communications device(s). The called party's availability and preferences may be additionally or alternatively obtained by invoking a web-services application, such as a CSF profile management capability.

Another example describes blended services for residential and/or enterprise end users. As FIG. 11 illustrates, these blended or composite application services 192 may be decomposed into simpler services that are architected either on the IMS portion 180 or on the WSP portion 178 of the middle layer 44. Whatever the architecture, the component parts of these composite application services are stand-alone and may be reused in any combinations. In other words, these composite application services are not built as having one application inside another in order to create a composite or blended application. These composite application services, for example, should discourage the building of voice/VoIP capability inside a gaming application. Exemplary embodiments, instead, build the gaming and voice/VoIP capabilities as autonomous applications that can be blended through the metaservice broker 174. Exemplary embodiments thus blend the voice/VoIP service with another application (like Video-on-Demand) to create a new composite or blended service. The conventional architecture would build VoIP capabilities into both gaming and VoD, a redundant and wasteful approach.

Quality of Service and resource management are also provided. The predominant use of IP networks to date has been on a best-effort basis. As more and more services are architected to use the common underlying IP network for connectivity, the management of core network resources, as well as resources associated with access networks, progressively assumes greater significance. Thus, a user who may have simultaneous IPTV, VoIP, and internet access sessions should have some access/network/resource QoS management capabilities in place to be able to receive satisfactory service without one application being able to deteriorate the quality of another. Before the user is provided with any requested service, exemplary embodiments may first check and ascertain if any portion of the network has enough unused resources to satisfy the user's request. Thus, exemplary embodiments include a set of QoS/resource management policies and/or associated admission control functions to help ensure the user's resource and bandwidth needs are satisfied.

The “m²” portion 182 of the middle layer 44 may include other functions. The set of QoS/resource management policies and the admission control functions may be architected in the “m²” portion 182 of the middle layer 44. The WSP portion 178 of the middle layer 44, and the applications using it, may be more removed from the underlying communications network (shown as reference numeral 36 in FIGS. 1-10) than the left-side IMS portion 180 and applications. This is true because, historically, IMS has been specified and developed in close conjunction with, but still quite separately from, the underlying connectivity network. In fact, because of the relative scarcity of bandwidth in cellular networks where IMS has its roots, special attention is given in IMS to policy and bandwidth management, attention that may come in handy independent of the underlying IP network technology. On the other hand, WSP also needs to have a resource management module in place to control requests made of web services resources. The set of QoS/resource management policies and the admission control functions, then, may be a policy server in the “m²” portion 182 that can perform the role of a resource manager for both IMS and web services resources.

The IMS portion 180 may use different media-level access control and QoS policies. These have to do with decisions about whether a user is authorized to send or receive media and, if so, with what QoS. Access to information needed to make policy decisions, such as the profile of the user sending or receiving media, is provided by the core IMS entities. IMS uses COPS (Common Open policy Service) protocol to communicate policy related information using both provisioning and outsourcing models. The IMS specifications define a Policy Decision Function (PDF) to interface with the underlying connectivity network on one side and with Proxy-CSCF on the other side to administer admission control and enforce the implemented policies. IMS supports several QoS models. From link-layer resource reservation protocols to RSVP and DiffServ, service providers can implement a complete end-to-end QoS management system starting with the capabilities of the end user device. The most common method may turn out to be for end devices to use the link-layer protocols and for PDF, in conjunction with P-CSCF, to map link-layer bandwidth reservation flows to DiffServ codes in the network.

Exemplary embodiments include other architectures. All applications, whether architected in the IMS portion 180 or in the WSP portion 178, may use the policy and QoS management functions developed as part of the IMS infrastructure. Clearly, IMS applications may easily use such capabilities. Blended applications architected using the metaservice broker 174 may also use such IMS functions directly. Applications on the CSF side can access IMS policy and QoS management functions in one of two ways. One way is to position the PDF function in IMS as an m² capability with the web services interface 186. The second method is to have CSF applications that need policy and QoS control capability use metaservice broker 174 to get access to them in the core IMS architecture.

Exemplary embodiments thus improve next-generation communications services. The conventional “silo” paradigm of application development and rollout is unlikely to address the needs of a leading edge service provider and its customers. Exemplary embodiments, instead, describe an alternative deployment of the comprehensive middle layer 44 that uses modular, reusable capabilities that applications can invoke on a need basis. Some of middle layer functions support real-time (and traditionally very high reliability) applications, and some other functions support near-real-time (web-oriented) applications. The former may include components of the IP Multimedia Subsystem (IMS) which uses SIP as the dominant underlying technology and protocol. The other parts of the middle layer, called Web services platform (WSP), use web services technologies in support of pure web applications. Although an IMS+WSP architecture satisfies a good portion of middle layer requirements, the “middle of the middle” or “m²” portion 182 of the middle layer 44 support service creation and scenarios for converged or bundled services. The QoS and resource/policy management functions may be provided by the IMS part of the middle layer 44 or, alternatively, as m² capabilities.

Exemplary embodiments may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments. A computer program product comprises processor-executable instructions for accessing common functions.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of accessing common functions for multiple applications, comprising:
receiving a request for service comprising at least one of a common set of application programming interfaces in an instruction to execute an application;
accessing a common set of application service interfaces allowing access to modular functions that are common amongst the multiple applications;
sending an application service interface in an instruction to execute a modular function;
receiving a result of the modular function; and
executing the application.

2. A method according to claim 1, further comprising accessing a common set of connectivity interfaces to a network.

3. A method according to claim 1, wherein accessing the common set of application service interfaces comprises accessing functions that are common between Session Initiation Protocol applications and web-based applications.

4. A method according to claim 1, wherein accessing the common set of application service interfaces comprises accessing a set of SIP-based capabilities and a set of web services capabilities.

5. A method according to claim 1, wherein accessing the common set of application service interfaces comprises accessing a Serving Call Session Control Function that manages sessions in an IP Multimedia Subsystem.

6. A method according to claim 1, wherein accessing the common set of application service interfaces comprises accessing an interface to a centralized database that stores customer subscription and service data for the multiple applications.

7. A method according to claim 1, wherein accessing the common set of application service interfaces comprises accessing an interface to i) a common authentication function for the multiple applications, ii) a common subscription function for the multiple applications, iii) a common profile function for the multiple applications, iv) a common presence function for the multiple applications, and v) a common billing function for the multiple applications.

8. A method according to claim 1, wherein accessing the common set of application service interfaces comprises accessing a common Proxy Call Session Control Function for the multiple applications.

9. A method according to claim 1, wherein accessing the common set of application service interfaces comprises accessing an interface to a common Border Gateway Control Function for the multiple applications.

10. A method according to claim 1, wherein accessing the common set of application service interfaces comprises accessing an interface to a common identify management function for the multiple applications.

11. A method according to claim 1, wherein accessing the common set of application service interfaces comprises accessing an interface to a common web-session management function for the multiple applications.

12. A method according to claim 1, wherein accessing the common set of application service interfaces comprises accessing an interface to a meta-service broker that blends autonomous applications.

13. A method according to claim 12, wherein accessing the interface to the meta-service broker comprises blending a Voice-over Internet Protocol application with a video-on-demand application.

14. A system for accessing common functions for multiple applications, comprising:
a processor communicating with memory, the memory storing instructions for receiving a request for service comprising at least one of a common set of application programming interfaces in an instruction to execute an application;
accessing a common set of application service interfaces that allow access to modular functions that are common amongst the multiple applications;
sending an application service interface in an instruction to execute a modular function;
receiving a result of the modular function; and
executing the application.

15. A system according to claim 16, the memory further storing instructions for accessing a common set of connectivity interfaces to a network.

16. A system according to claim 16, the memory further storing instructions for accessing functions that are common between Session Initiation Protocol applications and web-based applications.

17. A system according to claim 16, the memory further storing instructions for accessing a set of SIP-based capabilities and a set of web services capabilities.

18. A computer program product storing computer-readable instructions for:
receiving a request for service comprising at least one of a common set of application programming interfaces in an instruction to execute an application;
accessing a common set of application service interfaces that allow access to modular functions that are common amongst the multiple applications;
sending an application service interface in an instruction to execute a modular function;
receiving a result of the modular function; and
executing the application.

19. A computer program product according to claim 18, further comprising instructions for accessing a common set of connectivity interfaces to a network.

20. A computer program product according to claim 18, further comprising instructions for accessing functions that are common between Session Initiation Protocol applications and web-based applications.
